(19) United States
(12) Patent Application Publication
(10) Pub. No.: US 2009/0155589 A1
(43) Pub. Date: Jun. 18, 2009

(54) Fibrous fine carbon particles and method for producing the same

(76) Inventors: Hiroyuki Aikyou, Kanagawa-ken (JP); Toshifumi Shiroya, Kanagawa-ken (JP); Masaki Yamamoto, Kanagawa-ken (JP); Takashi Kyoutani, Kanagawa-ken (JP)

Correspondence Address: NIXON & VANDERHYE, PC, 901 NORTH GLEBE ROAD, 11TH FLOOR, ARLINGTON, VA, 22203, US

(21) Appl. No.: 11/596,857

(22) PCT Filed: May 20, 2005
(86) PCT No.: PCT/JP05/09262

§ 371 Date: Sep. 8, 2008

(30) Foreign Application Priority Data
May 27, 2004 (JP) 2004-158035

(51) Int. Cl. C01B 31/02; B01J 13/00; B82B 1/00; B82B 3/00

(52) U.S. Cl. 428/402; 516/98; 423/445 B; 977/742; 977/842

(57) ABSTRACT

Fibrous fine carbon particles of a novel structure improved in dispersibility in the dispersing media are provided. These particles have a minor diameter of 5 nm to 5 μm and have a rugged structure in which the mean value of surface roughness defined by the following equation (I) is not less than 8.0%:

Surface roughness(%)=((Sd−Hd)/Hd) (I)

(In determination of surface roughness, surface ruggedness of the fine carbon particles is measured by AFM Tapping Mode, forming the two-dimensional images of the particles from the obtained data, then an arbitrary straight line is selected on the two-dimensional images, forming the outline from the above data corresponding to the said straight line, then a section of measurement (S) is selected, said section being an area where the length of the virtual straight line connecting the two points on the said outline is within the range of 20 to 35 nm, and with the length of the virtual straight line between the said two point being represented by Hd and the length of the actual outline between the two point being represented by Sd, surface roughness is calculated from the above equation (I); the section of measurement (S) is a portion where the deviation of the outline from the virtual straight line is ±0.5 Hd.)

### TECHNICAL FIELD

The present invention relates to the fibrous fine carbon particles and a method for producing them.

### BACKGROUND ART

The carbon nanotubes having the configuration of a cylindrically winding two-dimensionally developed graphitized carbon structure are not only useful as conductive fillers but are also expected to find application to many other uses. As the methods for producing such carbon nanotubes, there are currently known arc discharge method and chemical vapor deposition (CVD) method (Patent Documents 1 and 2).

### Patent Document 1: Japanese Patent Application Laid-Open (KOKAI) No. 7-165406

### Patent Document 2: Japanese Patent Publication (KOKOKU) No. 3-64606

The conventional carbon nanotubes are unsatisfactory in dispersibility when used as a dispersion in a medium.

### DISCLOSURE OF THE INVENTION

### Problem to be Solved by the Invention

The present invention has been made in view of the above circumstances, and its object is to provide fibrous fine carbon particles of a novel structure which are improved in dispersibility in the dispersing media, and a method for producing such carbon particles.

### Means for Solving the Problem

As a result of present inventors' earnest studies on the subject matter, it has been found that by incorporating a specific carbonizing means in the production process, it is possible to obtain the fibrous fine carbon particles having a novel structure, which have been nonexistent hitherto.

Thus, in the first aspect of the present invention, there are provided fibrous fine carbon particles having minor diameter of 5 nm to 5 μm and having a rugged structure in which the mean value of surface roughness defined by the following equation (I) is not less than 8.0%:

Surface roughness(%)=((Sd−Hd)/Hd) (I)

(wherein in determination of surface roughness, surface ruggedness of the fine carbon particles is measured by AFM Tapping Mode, forming the two-dimensional images of the particles from the obtained data, then an arbitrary straight line is selected on the two-dimensional images, forming the outline from the above data corresponding to said straight line, then a section of measurement (S) is selected, said section being an area where the length of the virtual straight line connecting the two points on the said outline is within the range of 20 to 35 nm, and with the length of the virtual straight line between the said two point being represented by Hd and the length of the actual outline between the two point being represented by Sd, surface roughness is calculated from the above equation (I); the section of measurement (S) is a portion where the deviation of the outline from the virtual straight line is ±0.5 Hd.)

In the second aspect of the present invention, there are provided fibrous fine carbon particles having formed therein a single hollow portion enclosed by a carbon crystal wall and having a structure in which the carbon crystal edge is exposed at least at both ends of the particles, which fibrous fine carbon particles has the major diameter of 40 nm to 10 μm and the minor diameter of 5 nm to 5 μm.

In the third aspect of the present invention, there is provided an aggregate of the above fibrous fine carbon particles having such a property that with reference to the dispersion prepared by the method described below, the particle size distribution index A determined by allowing the dispersion to stand for 24 hours after its preparation and represented by the following equation (II) is 0.1 to 20:

### <Preparation of Dispersion>

3 ml of a dispersing medium and 1 mg of a specimen are placed in a glass vessel having an inner diameter of 13 mm and a capacity of 5 ml and, after closing the vessel with a cover, it is shaken with hands to disperse the specimen.

Particle size distribution index A=(D₉₀−D₁₀)/D₅₀ (II)

(wherein D₉₀, D₅₀ and D₁₀ indicate the diameters (unit: μm) of the particles with 90 vol %, 50 vol % and 10 vol %, respectively, as counted from the smallest particle diameter.)

In the fourth aspect of the present invention, there is provided a dispersion of the fibrous fine carbon particles formed by dispersing the fibrous fine carbon particles as defined in the third aspect in a dispersing medium.

In the fifth aspect of the present invention, there is provided a method for producing the fibrous fine carbon particles of the first aspect which comprises using as raw material the fibrous carbon precursor particles of a predetermined length with its minor diameter being selected from the range of 5 nm to 5 μm, and carbonizing said raw material in its proto-shaped mold.

In the sixth aspect of the present invention, there is provided a method for producing the fibrous fine carbon particles as defined in the second aspect which comprises using as raw material the fibrous carbon precursor particles of a predetermined length with its major diameter being selected from the range of 40 nm to 10 μm and its minor diameter selected from the range of 5 nm to 5 μm, and carbonizing the raw material in its proto-shaped mold.

### EFFECT OF THE INVENTION

The fibrous fine carbon particles of the present invention have excellent dispersibility, are easy to handle, and can be dispersed uniformly without causing flocculation in a dispersing medium when blended with other materials, and consequently they are capable of developing uniformly the advantageous electrical properties such as electroconductivity and electric field releasability.

### BRIEF DESCRIPTION OF THE DRAWINGS

FIG. 1 is a schematic illustration of a two-dimensional image of a fine carbon particle.

FIG. 2 is an analytical chart of the outline of a fine carbon particle.

FIG. 3 is an enlarged view of the analytical chart of FIG. 2.

FIG. 4 is schematic illustrations of the structures of the fibrous fine carbon particles of the present invention.

FIG. 5 is a schematic illustration showing the types of surface structure of the end portion that the fibrous carbon particles of the present invention can posses.

### DESCRIPTION OF REFERENCE NUMERALS

1: fibrous fine carbon particle
2: carbon crystal wall
3: hollow portion
10: ends of the fibrous fine carbon particle
a: structure in which the carbon crystal edges are exposed
b: loop structure of the carbon netplane in the fine carbon particle surface

### BEST MODE FOR CARRYING OUT THE INVENTION

The present invention will be described in detail below, but it should be understood that the present invention is not limited to the following embodiments but various changes and modifications are possible within the scope of the present invention.

### <Method of Producing Fibrous Fine Carbon Particles According to the Present Invention>

First, for the convenience of explanation, a method of producing the fibrous fine carbon particles according to the present invention is described.

In the present invention, the fibrous carbon precursor particles of a predetermined length are used as raw material, and this material is carbonized in its proto-shaped mold. The present invention embraces two methods for producing the said particles, but the two methods merely differ in the way of specification of the fibrous fine carbon particles. Namely, in the first method, only the length of the minor diameter of the particles is specified, while in the second method, the lengths of both minor and major diameters are specified. Defining of the major diameter in the second method is a preferred embodiment in the first method. Therefore, the following description applies to both of the first and second methods, exclusive of the description regarding the fibrous carbon precursor particles. Although the following description regarding the fibrous carbon precursor particles is given with reference to the embodiment in the first method, it can as well be applied to the second method provided that both the minor and major diameters are specified.

In the present invention, the fibrous carbon precursor particles whose minor diameter falls within the range of 5 nm to 5 μm are used as raw material. In a preferred embodiment of the present invention, the major diameter of the particles is defined to be 40 nm to 1,000 μm. The preferred range of major diameter is 40 nm to 100 μm, more preferably 40 nm to 10 μm. The expression “fibrous” used in the present invention refers to the particles having an aspect ratio of usually 2 or more. The configurations of the fibrous carbon precursor particles and the fibrous fine carbon particles according to the present invention can be confirmed by scanning or transmission electron microscopical observation.

The material used as the carbon precursor is not subject to any specific restrictions, but a material capable of liquid phase carbonization is preferred in view of induction of crystalline carbon structure. Typical examples of such material include polyacrylonitrile and its copolymers, polyvinyl alcohol, polyvinyl chloride, phenolic resins, rayon and pitch. Of these materials, polyacrylonitrile and its copolymers are preferred for the reason that a liquid phase operation allowing easy control of crystallinity is involved at the stage of carbonization of these materials. Control of crystallinity can be effected by a simple operation, such as changing the temperature condition for carbonization. The term “liquid phase carbonization” used in the present invention refers to a process of carbonization in which a thermochemical reaction proceeds in a liquid phase after the solid has passed through a fluid state of a higher level than that at the glass transition temperature Tg, and the migration or orientation of the molecules is relatively likely to occur.

Usually, for obtaining a carbonized product by carbonizing an organic polymer in an inert gas atmosphere, a polymer capable of providing a high yield of carbonization is used as precursor. In the present invention, however, since carbonization is carried out in a proto-shaped mold, the loss by thermal decomposition is controlled in comparison with carbonization of the ordinary organic materials. In the present invention, therefore, it is possible to induce the objective carbonized products even from the polymers other than those mentioned above in a high yield.

In the present invention, it is preferable to contain a pyrolytic polymer in the carbon precursor. Such easily heat-decomposable polymers are usually decomposed when heated to 500° C. or higher under normal pressure in an inert atmosphere. These polymers facilitate plastic deformation of the carbon precursor (liquid phase carbonizable material) in the heating process for carbonization of the carbon precursor. Also, they are heat-decomposed in a high temperature region to become a gas, forcing the carbon precursor to distend from the inside by its pressure to promote formation of the hollow particles. The carbon precursor distended by the gas pressure is pressed against the wall of a heat-resistant material (to be described later) coated on the outer surfaces of the particles, allowing progress of carbonization on the spot while accelerating crystallization. As for the amount of the easily heat-decomposable polymer to be contained, since its use in too much quantity may cause damage to the formed carbon crystal wall, the ratio of the said polymer to the combined amount of the carbon precursor and the said polymer is usually 2 to 70% by weight, preferably 2 to 50% by weight.

Examples of such easily heat-decomposable polymers usable in the present invention include polystyrene, polymethylacrylate, polymethylmethacrylate, polyethylene and polypropylene. As methods for containing an easily heat-decomposable polymer in the carbon precursor, there exemplified a method in which they may be simply melt mixed, or the component monomers may be copolymerized in a suitable compositional ratio and a method in which seed polymerization for having the composition unevenly distributed is conducted.

The fibrous carbon precursor particles can be obtained, for instance, by dispersing the particles (particles to be stretched) which is made from material capable of a liquid phase carbonization in other matrix polymer, stretching the particles and then separating the matrix polymer. As the matrix polymer, in view of ease of separation after stretching and other factors such as dispersibility of the particles to be stretched, polyvinyl alcohol is preferably used when the liquid phase carbonizable material is not polyvinyl alcohol. The length of the fibrous carbon precursor particles can be controlled by selecting their stretch ratio. The diameter of the particles to be stretched is usually 10 nm to 2 μm. This diameter can be confirmed usually by scanning electron microscopical (SEM) observation.

In case of using the precursor particles which are fixed in both major and minor diameters and also uniformalized in shape, such particles can be produced, for instance, by the following method. First, the particles (particles to be stretched), substantially uniform in diameter, of a liquid phase carbonizable material (which becomes a carbon precursor) are dispersed in other matrix polymer, then this dispersion is stretched in a predetermined ratio into the form of thread or film, and then the matrix polymer is separated away. This method provides precursor particles uniformalized in shape. In case where the particles (particles to be stretched) with a uniform diameter are those of an organic polymer, they can be synthesized as emulsion particles by emulsion or soap-free polymerization.

The method for stretching the fibrous carbon precursor particles is not specifically defined in the present invention; it can be effected, for instance, by spinning a solution or a melt of the precursor material. It is possible with this method to obtain the fibers uniform in diameter. The diameter of the fibers corresponds to the minor diameter of the fibrous carbon precursor particles, and there can be obtained the fibers having a desired diameter corresponding to the minor diameter of the particles by adjusting the spinning nozzle diameter and the draw-out speed. The spinning methods usable for this purpose include drying spinning, wet spinning, melt spinning and electric spinning. The fibers can be adjusted to a length corresponding to the major diameter of the particles by treating the fibers by a suitable method such as cutting or grinding. In this way, it is possible to obtain the fibrous carbon precursor particles having the desired minor and major diameters.

The method of producing the fibrous fine carbon particles according to the present invention is characterized by using the said fibrous carbon precursor particles as the raw material and carbonizing this raw material in its proto-shaped mold. In a preferred embodiment of the present invention, the proto-shaped mold of the said raw material is formed by coating this raw material with a heat-resistant material.

The heat-resistant material needs to be one which does not affect the configuration of the raw material by its own thermal deformation at a temperature below the level at which the raw material is carbonized. The preferred ones of such heat-resistant materials have the characteristics that their linear thermal shrinkage rate in the temperature range of 50 to 500° C. is not more than 30%. It is also preferable that these materials have no definite glass transition point (Tg) in the temperature range of 100 to 500° C. Further, these materials are preferably ones which can be removed by a simple method after carbonization by heating.

Inorganic oxides are preferred as the heat-resistant materials which meet the said property requirements. Examples of such inorganic oxides include SiO₂, Al₂O₃, TiO₂, ZrO₂₁ In₂O, ZnO, PbO, Y₂O₃, BaO, and mixtures thereof. Of these materials, SiO₂, Al₂O₃, TiO₂ and ZrO₂ are preferred in view of desired purity of the fine carbon particles and control of metallic impurities, with SiO₂ being particularly preferred because it conduces to stable proceeding of carbonization reaction of the precursor particles and crystallization.

As means for coating the raw material, there can be used, for instance, a sol-gel method using a metal alkoxide or the like of the said inorganic oxides as raw material, and a method in which the fibrous carbon precursor particles are coated with a solution of a soluble inorganic compound such as a nitrate or an oxychloride salt. In another method of forming the proto-shaped mold, the fibrous carbon particles are coated with an inorganic compound solution such as water glass and dried.

The method of coating the fibrous precursor particles by the sol-gel method using a metal alkoxide has the advantage of providing a uniform rugged configuration to the surface of the carbonized product because the proto-shaped mold obtained after gelation has a property of fine porosity.

In case of coating with SiO₂, the following method may be used. First, an alkoxysilane is added to a solution of an alcohol such as methanol or ethanol, after which water is added and the mixture is stirred at room temperature for several hours for carrying out hydrolysis to prepare a silicate sol solution. In preparation of this sol solution, usually its pH is adjusted properly for controlling sol stability and reactivity by adding an appropriate substance such as oxalic acid, acetic acid, hydrochloric acid, sulfuric acid, ammonia or the like as a catalyst. Then the fibrous carbon precursor particles are mixed in the sol solution, and the mixture is allowed to stand at room temperature to 40° C. for several hours to several days until gelation is reached, thereby obtaining a silica gel having the fibrous carbon precursor particles dispersed therein. It is also possible to use a method in which a silicate sol solution is sprayed to the fibrous carbon precursor particles.

Examples of the alkoxysilanes usable for the above purpose include tetraalkoxysilanes such as tetramethoxysilane, tetraethoxysilane, tetraisopropoxysilane, tetrabutoxysilane and oligomers thereof, and alkyltrialkoxysilanes such as methyltrimethoxysilane, methyltriethoxysilane, ethyltrimethoxysilane and ethyltriethoxysilane. Two or more types of alkoxysilane may be used simultaneously depending on the process conditions for gelation and dispersibility of the particles in the coating operation.

In the above coating method, it is effective for enhancing heat resistance of the coating composition to increase the density of siloxane bonds forming the chemical structure in the silica gel, either by vacuum drying the fibrous carbon precursor particles defined in surface configuration by silica gel, or by heating the particles within the temperature range causing no thermal deformation of the particles.

Carbonization is carried out by heating the carbon precursor, which has been coated with a heat-resistant material on the surface, for a predetermined period of time in an atmosphere free of any substance which may react with the said precursor during heating such as nitrogen and argon. The heating atmosphere may be either flow system or closed system, but the flow system is preferred. Heating may be conducted either under pressure or under reduced pressure, but usually it is carried out under normal pressure. When heating is conducted under normal pressure, the heating temperature is usually not lower than 500° C., preferably not lower than 800° C. Also, heating may be performed by raising the temperature either successively or stepwise till reaching the predetermined temperature. The heating time, although variable depending on the heating temperature and other factors, is usually 0.5 to 2 hours after the predetermined heating temperature has been reached.

After carbonization, the heat-resistance material on the surface is removed by a suitable method, for instance, dissolving the said material with an alkaline solution of sodium hydroxide or the like or with hydrofluoric acid. As an industrially safe method, the method of dissolving with an alkaline solution is preferably used. Usually, a method is used in which the material is dissolved by heating it to 150° C. in a pressure-resistant closed vessel, the remaining fine carbon particles are separated into solids and liquid and the solids are recovered. In case where polyacrylonitrile is used as the carbon precursor, the yield of the fine carbon particles obtained by the above method is usually not less than 30% by weight and falls in most cases within the range of 35 to 45% by weight.

According to the method of the present invention, it is possible to obtain the fibrous fine carbon particles having a specific surface configuration and uniform in size, and further, as another advantage to the present invention, it is possible to design the final product at the stage of precursor.

In the course of liquid phase carbonization of the carbon precursor, ruggedness is formed on the carbonized product surface at the interface between the carbon precursor and the proto-shaped mold. Thus, ruggedness of the carbonized product surface is obtained as the carbon precursor is carbonized while reflecting the surface configuration of the proto-shaped mold when the precursor is softened in the course of heating.

Moreover, the method of the present invention is capable of forming the carbonized product at a relatively low carbonization temperature, and quite notably the obtained carbon particles have high crystallinity. Particularly in case where the precursor is a liquid phase carbonizable material, the mesophase in the carbonization process greatly governs the crystal structure of the product after carbonization, and the surface properties of the heat-resistant material coating the product surface largely influence the crystallinity of the product. In case where an organic polymer such as polyacrylonitrile is used as precursor, as an effect of the surface functional group of the heat-resistant material on the carbon radicals produced in the course of carbonization, a large influence on crystallinity and orientation is pointed out. As the surface functional group, silanol groups, hydroxyl groups, ketone groups and ester groups can be cited as typical examples.

In case where there exist many hydroxyl groups, which are hydrophilic groups, in the surface of the heat-resistant material, since carbon radicals are stabilized, the edge portions of carbon crystalline are oriented. That is, it is considered that the carbon particles obtained after carbonization assume a form of crystal orientation in which the a-axis of crystal is oriented vertically toward the outer periphery of the particles. Crystallinity is usually higher than that of the fine carbon particles obtained by carbonizing the precursor particles without using a coating material.

Conversely, in case where the hydroxyl groups are scanty in the heat-resistant material surface, the surface becomes hydrophobic and the hexagonal netplane of the benzene ring being formed in the mesophase tends to orient. It is thus considered that the carbonized product tends to show an orientation which lessens the crystal edge portion, that is, a concentric circular orientation toward the outer periphery of the particle from its center.

By virtue of the above-described effects of the method of the present invention, the fibrous fine carbon particles obtained by the method of the present invention have a novel structure unknown in the art as explained below.

### <Fibrous Fine Carbon Particles in the First Embodiment of the Present Invention>

Here, the fibrous fine carbon particles in the first embodiment of the present invention are described. The fibrous fine carbon particles of the present invention are the particles having a minor diameter of 5 nm to 5 μm and characterized by having a rugged structure with a surface roughness, as defined by the following equation (I), of not lower than 8.0%.

The fibrous fine carbon particles of the present invention are of an acicular or elliptical form elongated in one direction. The minor diameter of these particles falls within the range of 5 nm to 5 μm. In case where the minor diameter differs according to the part of the particle, the largest part selected from those of different minor diameters has a value of minor diameter in the above-defined range. The range of major diameter is not specifically defined, but it is preferable that the particles are uniform in major diameter in view of dispersibility when dispersing the particles in other material and ease of handling. The major diameter of the particles is in the range of usually 40 nm to 1,000 μm, preferably 40 nm to 100 μm, more preferably 40 nm to 10 μm.

The aspect ratio, or the ratio of minor diameter to major diameter, of the fibrous fine carbon particles of the present invention is usually not less than 2, preferably not less than 3, in view of electric field releasability, electroconductivity, and miscibility and/or dispersibility in other types of solid material such as resins. The upper limit of the aspect ratio is usually 20,000, preferably 10,000, more preferably 8,000, in view of handling quality of the material in working thereof.

In the present invention, as an index of the rugged surface structure of the fibrous fine carbon particles, reference is made to the surface roughness determined by the method described below and defined by the following equation (I).

Surface roughness(%)=((Sd−Hd)/Hd) (I)

(In determination of the surface roughness, surface ruggedness of the fine carbon particles is measured by AFM Tapping Mode, forming the two-dimensional images of the particles from the obtained data, then an arbitrary straight line is selected on the two-dimensional images, forming the outline from the above data corresponding to the said straight line, then a section of measurement (S) is selected, the said section being an area where the length of the virtual straight line connecting the two points on the said outline is within the range of 20 to 35 nm, and with the length of the virtual straight line between the said two point being represented by Hd and the length of the actual outline between the two point being represented by Sd, surface roughness is calculated from the above equation (I); the section of measurement (S) is a portion where the deviation of the outline from the virtual straight line is +0.5 Hd.)

AFM (atomic force microscope) is a type of scanning probe microscope, and in the Tapping Mode, the probe moves springing up and down on the specimen surface to determine the surface condition (ruggedness). “Tapping Mode” is a registered trademark of Veeco Inc., U.S.

For the measurement of surface roughness, for instance a method based on Ra is known. This method can be applied to the materials having a large and flat surface area like a film, but is useless for the measurement of the fibrous fine carbon particles of the present invention which are nanosized and whose area to be measured is a small curvature. In the present invention, therefore, surface roughness defined by the above equation (I) is adopted.

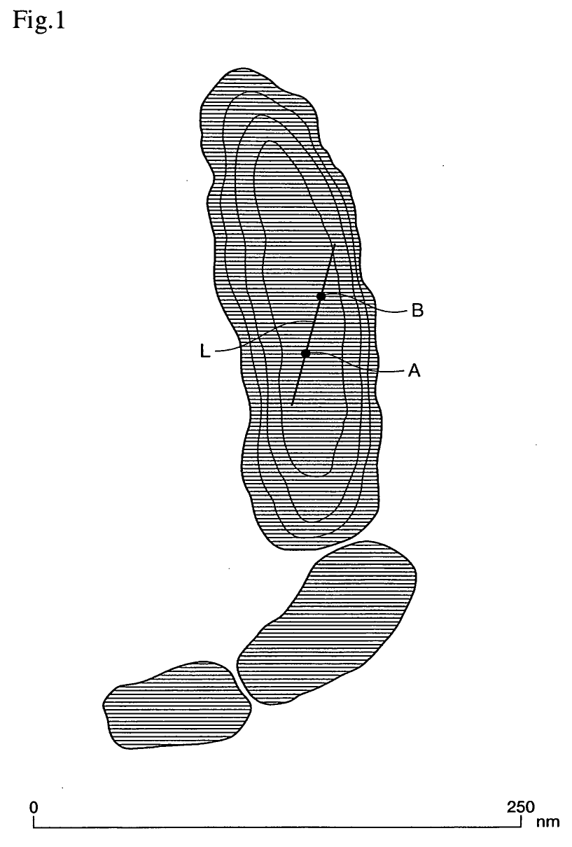

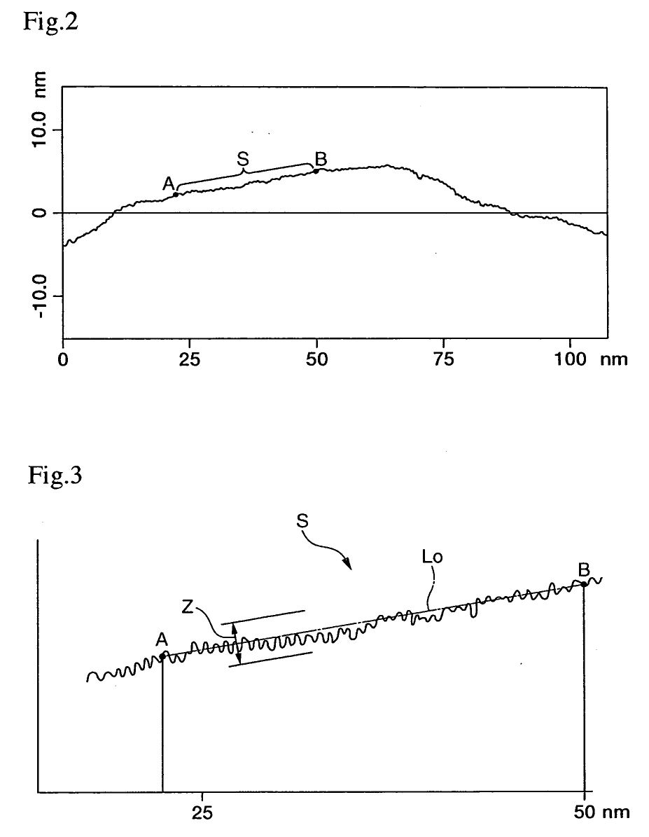

FIG. 1 is a schematic illustration of a two-dimensional image of a fine carbon particle, FIG. 2 is an analytical chart of the outline of a fine carbon particle, and FIG. 3 is an enlarged view of the analytical chart of FIG. 2. In the following, the steps for calculating surface roughness are explained with reference to these drawings.

(1) First, surface ruggedness of the fine carbon particles is determined by AFM Tapping Mode, and the two-dimensional images of the particles are drawn based on the obtained data. The horizontal lines in FIG. 1 indicate the scanning direction of the probe and are the data (ruggedness) obtained by scanning. The lines enclosing the aggregates of these data are the outlines showing visual appearance of the fine carbon particle, and the contour lines show the visual shape of the particle.

As an example of rugged surface configuration of the fibrous fine carbon particles of the present invention, the peaks and bottoms of the ruggedness adjoin each other with a gap of not more than 1 nm between them, and the ruggedness of 0.1 nm to 1.0 nm in high/low difference exists continuously on the particle surface. This high/low difference is a numerical value obtained from an analysis of the two-dimensional images of the fine carbon particles drawn based on the date obtained from AFM Tapping Mode determination. The range of measurement in AFM surface measurement may be, for instance, from 100 nm square to 1,000 nm square.

(2) Then, an arbitrary straight line (L) is selected on the two-dimensional image, and the outline is drawn from the above data corresponding to this straight line (FIG. 2). In FIG. 1, the straight line (L) is selected from a flat portion as much as possible.
(3) Then, a section for measurement (S) is selected, the said section (S) meeting the requirement that the length of the virtual straight line (L0) connecting the two points (A-B) on the said outline is within the range of 20 nm to 35 nm, and with the length of the virtual straight line between the two points (A-B) being represented by Hd and the length of the actual outline between the said two points being represented by Sd, surface roughness is calculated from the equation (I). The measurement section (S) needs to be an area where the deviation (Z) of the outline from the virtual straight line (L0) is ±0.5 Hd. Actually, an area where the deviation (Z) of the outline from the virtual straight line (L0) is ±0.5 Hd is selected as the measurement section (S), and surface roughness is calculated from the above-shown equation (1).

The concrete object of analysis in each image analyse in (2) and (3) may be, for instance, an area of from 50 nm square to 100 nm square. The data sampling density in each visual field for analysis is in the range of 126 to 1,024 in both X-direction and Y-direction, and it is possible to carry out the analysis by setting the range of visual field and pixels so that the visual field range will become 0.10 nm to 0.40 nm per one pixel gap. The number of objects for analysis should be not less than 2, preferably not less than 5, more preferably not less than 10 in analytic fields of view. The mean of the values of surface roughness obtained from the respective visual fields is determined.

The surface roughness, as determined in the manner described above, of the fibrous fine carbon particles of the present invention is not less than 7.0%, preferably not less than 8.0%, more preferably not less than 9.0%. If the surface roughness is less than 7.0%, there can not be obtained the desired effect of improving dispersibility in media. The upper limit of surface roughness is usually 55%, preferably 30%.

The fibrous fine carbon particles according to the present invention have a substantially rectilinear fibrous shape with a specific aspect ratio. Therefore, these carbon particles are different from the carbon black particles with a primary or secondary structure and the carbon nanofibers of the coiled or crooked configurations.

Since the fibrous fine carbon particles of the present invention are produced by liquid phase carbonization in a proto-shaped mold, the produced particles have a structure which is hollow in the inside and closed at the ends. The size of the hollow portion can be freely controlled by placing a liquefiable carbon material in this hollow portion and repeating the said carbonization in the proto-shaped mold. Other means for controlling the hollow portion size comprises increasing the viscosity of the carbon precursor polymer at the time of its carbonization, or decreasing the amount of the pyrolytic polymer used. By elevating the viscosity or by controlling generation of heat-decomposable gas from the precursor polymer, the small air bubbles are prevented from coalescing into the larger bubbles, and this is considered making it possible to reduce the size of the hollow portion. Ultimately, it is possible to totally eliminate the hollow portion.

However, it is preferable that the particles are of a structure having a hollow portion in the inside for the reasons that they can be used as a material of a low specific gravity, and that a desired material can be carried in the inside. In this case, in view of its function to hold the carried material, the structure is preferably closed at one end, more preferably closed at both ends. Although each particle may have two or more hollow portions, preferably each particle has one hollow portion because of better controllability when an alien substance is carried in the hollow portion. Also, the hollow portion may be comparted into plural sections by amorphous carbon walls. Air may not always exist in the hollow portion; it may be filled with a liquid or a solid.

The carbon content in the fibrous fine carbon particles may not necessarily be 100% by weight, but in view of chemical stability, it is usually not less than 70% by weight, preferably not less than 75% by weight, as determined by elemental analysis. Other elements contained in the particles are oxygen, nitrogen, etc., derived from the functional groups existing in the polymers used as precursor of the carbonized material.

The fibrous fine carbon particles of the present invention are preferably crystalline for the reason of maximal display of their performance after dispersed in a medium. Being “crystalline” referred to herein does not necessarily mean that the particles are controlled into a graphite-like structure, but they may take the structure of turbostratic graphite such as described in Koyama et al: KOGYO ZAIRYO (Industrial Materials), Vol. 30, No. 7, p. 109-115. The crystallographical properties determined from the reflection peaks of X-ray diffraction as a measure of crystallinity are indicated in the manner shown below. That is, in X-ray diffraction using CuKα as output source, peaks appear when the angle of diffraction 2θ is not less than 25.0° (preferably not less than 26.0°), and the full width at half maximum is not more than 7.0° (preferably not more than 6.5°, more preferably not greater than 5.0°), and the carbon netplane average interfacial distance d(002) calculated by the Bragg's formula from the angle of diffraction at 002 peak is not greater than 4.30 Å (preferably not more than 3.60 Å).

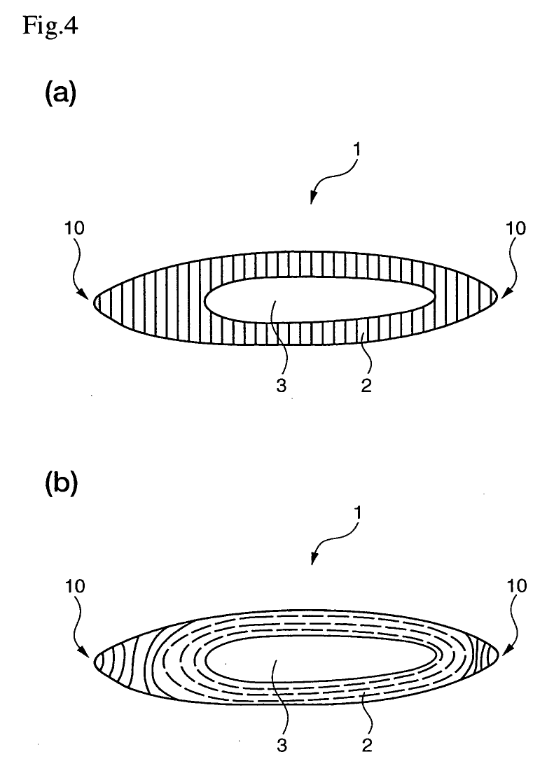

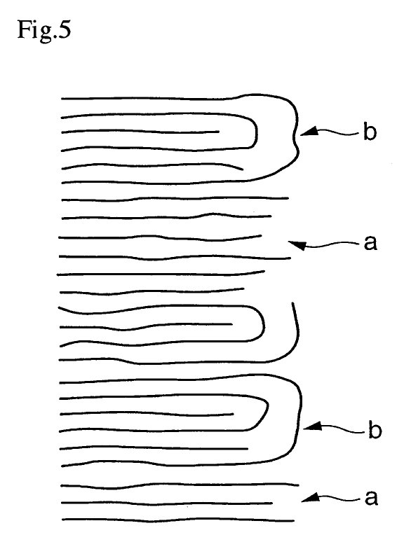

The fine carbon particles of the present invention are further described with reference to the embodiment in which the hollow portion is enveloped by a carbon crystal wall. FIG. 4 is a schematic illustration of the structure of the fibrous fine carbon particles of the present invention. The thickness of the carbon crystal wall 2, when expressed as its ratio to the distance (radius) from the center of the particle 1 to the perimeter of the wall, is usually not more than 0.5, preferably not more than 0.3, in view of capacity of holding other material in the hollow portion 3.

The fibrous fine carbon particles in this embodiment of the invention are preferably of a structure in which the carbon crystal edge is exposed at least at both ends of the structure. In this case, there are conceivable two types of structure. In one structure, as shown in FIG. 4(a), the carbon crystal edge is exposed in the entirety of the carbon particle, and in another structure, as shown in FIG. 4(b), the carbon crystal edge is exposed only at both ends of the structure. The term “end” used here means the portion in the range of length of up to 10% of the diameter in the longitudinal direction with the foremost tip as the starting point. These structures or a composite structure comprising both of these structures combined in a proper ratio can be obtained by controlling the effect of the surface functional groups of the coating material on the carbon radicals produced in the course of carbonization described above. This carbon crystal edge exposed structure, coupled with the rugged surface configuration, contributes to bettering dispersibility of the fibrous fine carbon particles in the dispersing media.

The “carbon crystal edge exposed structure” may be either of the type in which the carbon crystal edge is exposed on the surface or of the type in which the carbon netplane loop structure is present in the surface. Regarding the perimeter of the fibrous fine carbon particles of the present invention, an example of the structure in which the carbon crystal edge is exposed on the surface and an example having a carbon netplane loop structure in the surface are explained with reference to FIG. 5. FIG. 5 is a schematic illustration for showing a type of surface structure of the end portion that can be taken by the fibrous carbon particles of the present invention. (In this drawing, the inside of the particle is shown on the left side, and the outside of the particle is shown on the right side.) In FIG. 5, reference letter (a) indicates the carbon crystal edge exposed structure, and reference letter (b) indicates the carbon netplane loop structure in the particle surface. The loop structure is usually formed up to 20th layer of carbon netplane. The crystal orientation in the particle surface, that is, formation of the particles either with a crystal edge exposed structure or a carbon netplane loop structure can be confirmed by ×800,000 magnification TEM photographs. It is sufficient if this carbon crystal edge exposed structure or loop structure exists at the periphery of at least both ends of the particle. Since curvature is greater toward both ends of the particle, the effect of crystal edge exposure becomes more conspicuous at both ends. The ratio held by the said structure to the whole surface area of the particle periphery is usually not less than 3%, preferably not less than 5%, more preferably not less than 15%.

In the carbon crystal edge exposed structure (a), the carbon crystal faces are laminated substantially vertically to the longitudinal direction of the fiber. In the Preprints of Summaries at 30th Annual Meeting of Carbon Material Society (page 376), there is disclosed a carbon fiber having, as one of its characteristic features, a structure in which the carbon netplanes are laminated substantially vertically to the longitudinal direction of the fiber. This carbon fiber is of a carbon structure made by using polyvinyl chloride or polyvinyl alcohol as raw material and subjecting it to liquid phase carbonization using as mold the alumina-coated pores formed by anodization. Generally, according to the carbon fiber production method using as mold the pores having an oxide coating film, for example, anodized alumina coating formed by an electrochemical method, since the coating structure is fine, there exists little ruggedness at the interface with the mold at the time of generation of carbon, so that ruggedness in the surface of the carbon material is limited and, therefore, such carbon fiber structure can not produce the effect of the present invention.

The conventional carbon nanotubes (CNT) or carbon nanofibers are mostly obtained in an entangled state because of too large length or coiled or crooked configuration. So, when they are put to use as a dispersion in a solid, they are normally cut or pulverized by mechanical means or subjected to a chemical surface treatment. In contrast, the fibrous fine carbon particles according to the present invention are the particles having a length and a diameter in the specified ranges, which were obtained by using as raw material a carbon precursor having a length and a diameter in the certain defined ranges. Also, these carbon particles have specific small ruggedness on the surface and are different from conventional CNT.

As a carbon material of the carbon crystal edge exposed structure, there is known a carbon fiber of a herringbone-like carbon structure that can be produced by a vapor phase growth method using a metal catalyst as base (Pat. Appln. Laid-Open (KOKAI) No. 2003-5130). However, ruggedness created by crystal edge exposure in this carbon fiber is merely a difference in atom level or layer level of carbon crystal and smaller than defined in the present invention. This is evident from Comparative Example 2, too, which is given later.

Generally, the crystalline carbon materials have strong self-cohesiveness and tend to cohere or form a structure by themselves like carbon black, so that their high-degree dispersion in a different type of material is difficult. The carbon crystals are mostly of a structure having the basal plane facing the surface, and their surface is chemically inert and low in critical surface tension. Therefore, the carbon crystals are largely different in surface tension from and low in affinity for the different types of medium, particularly solvents of high polarity and hydrophilic materials, so that they can hardly be dispersed in these materials.

On the other hand, when the fibrous fine carbon particles of the present invention are stirred or mixed by a mixer, extruder or other means when dispersing them in a solvent, resin, paste or such, the surface ruggedness of the particles produces a physical anchor effect to better dispersibility in the medium.

At the rugged surface region of the carbon structure, the crystal structure becomes discontinuous and the crystal edges or highly strained carbon bonds exist at a high density. Such crystal edge or highly strained carbon bond has high potential energy and forms a chemically active site. Therefore, the rugged structure of the fibrous fine carbon particles of the present invention constitutes a chemically active site and shows an action as a site of high surface tensional energy. Consequently, the fibrous fine carbon particles of the present invention have good affinity for water and other polar media and can be easily dispersed in these media.

Particularly, to have a structure in which the carbon crystal edge is exposed at a site of high curvature at both ends of the particle, coupled with the effect of pointed shape of the particle ends, proves to be a factor for attaining dispersion in a medium more effectively. Thus, the fibrous fine carbon particles of such a structure have a higher dispersing effect and, in this sense, more advantageous than the particles of a structure in which the crystal edge is not exposed at both ends but merely exists in the surface of the fibrous particle.

### <Fibrous Fine Carbon Particles in the Second Embodiment of the Invention>

Now, the fibrous fine carbon particles in the second embodiment of the present invention are explained. In the carbon particles (1) of this embodiment, there is formed a single hollow portion (3) enclosed by a carbon crystal wall (2), and the carbon crystal edge is exposed at least at both ends of the particle (1). These particles measure 40 nm to 10 μm in major diameter and 5 nm to 5 μm in minor diameter.

As mentioned above, the conventional carbon nanotubes (CNT) are mostly produced in an entangled state due to their too large length. Therefore, the end structure of CNT, although not necessarily identified, is in most cases such that one end is terminated with a metal catalyst particle in the course of synthesis. The fibrous fine carbon particles (1) of the present invention, on the other hand, are of a structure having in the inside thereof a single hollow portion (3) enclosed by a carbon crystal wall (2). That is, the fibrous fine carbon particles (1) of the present invention have a structure with closed ends and are thus different from the conventional CNT. The expression “enclosed” used here means that, in the carbon crystal wall (2) enclosing the hollow portion, there exists no pore or void having a diameter greater than a certain specified value that communicates the outside of the particle with the inside hollow portion. Specifically, the requirement is satisfied if there exists no pore or void with a diameter more than usually several ten nm, preferably more than several nm, more preferably more than 1 nm, when observed by TEM photographs.

As CNT having a specific structure, there are known those of a structure in which a hollow space enclosed by a carbon crystal wall is formed and this hollow space is comparted into plural sections by the carbon crystal walls. The fibrous fine carbon particles (1) according to the present invention have only one hollow portion (3) enclosed by a carbon crystal wall (2) and are different from the said CNT having plural hollow portions enclosed by the carbon crystal walls. In the fibrous fine carbon particles of the present invention, the hollow portion (3) may be divided into plural sections by the amorphous carbon walls. The “hollow” in the fibrous fine carbon particles of the present invention does not always means a space where air exists, but it may also refer to a space which is filled with a liquid or a solid.

The fibrous fine carbon particles in the second embodiment of the present invention can be identical with those of the first embodiment with regard to exposure of the carbon crystal edge, thickness of the carbon crystal wall, carbon content of the particles and crystallinity.

The fibrous fine carbon particles in the second embodiment of the present invention are in the range of 40 nm to 10 μm in major diameter and 5 nm to 5 μm in minor diameter, with their aspect ratio (ratio of minor diameter to major diameter) being usually not less than 2, preferably not less than 3 in view of electric field releasability, electroconductivity, and miscibility or dispersibility in different types of solids such as resins. The upper limit of their aspect ratio is usually 2,000, preferably 1,000, more preferably 800 in view of handling quality in working of the particles.

In the structure shown in FIG. 4(a), the carbon crystal faces are laminated substantially vertically to the longitudinal direction of the fiber. Japanese Patent Application Laid-Open (KOKAI) No. 3-146716 discloses a carbon fiber having, as one its features, a structure in which the carbon netplanes are laminated substantially vertically to the longitudinal direction of the fiber (this structure has been confirmed by the ×800,000 magnification TEM observation images). This carbon fiber is obtained by a method comprising heat treating a mixture of carbon monoxide and hydrogen in the presence of an iron carbonyl catalyst. This carbon fiber, however, is characterized by having substantially no hollow portion and obviously different from the fibrous fine carbon particles such as shown in FIG. 4(a). In the case of the carbon fiber produced by a vapor phase growth method using a metal catalyst such as mentioned above, the growth of crystal in the process of fiber growth is generally continuous and homogeneous, so that it is considered that such a carbon fiber is incapable of having surface ruggedness of a fine pitch such as prescribed with the fibrous fine carbon particles in the first embodiment of the present invention.

The overall length and shape of the fibrous fine carbon particles in the first and second embodiments of the present invention can be confirmed by the observation images by TEM with a magnification of ×50,000 or over. SEM (scanning electron microscope) may be used as a more simple method. The structure having a single hollow portion in the inside and the presence or absence of an amorphous component with no hollow portion in the structure can be confirmed by a contrast of the observation images taken with TEM with a magnification of ×800,000 or over. The situation showing the same contrast as in the case of having a hollow, such as the presence of water, is also considered to be included in the concept of hollow. The structure at both ends (closed structure and the direction of lamination of the carbon crystal faces) can be confirmed by a contrast of the observation images by TEM with a magnification of ×100,000 to ×800,000.

### <Aggregate of Fibrous Fine Carbon Particles>

The aggregate of the fibrous fine carbon particles according to the present invention will now be explained. The particle aggregate of the present invention comprises the fibrous fine carbon particles in the second embodiment of the present invention described above, and is characterized in that the particle diameter distribution index A defined by the following equation (II), as determined by preparing a dispersion by the method described below and allowing the dispersion to stand for 24 hours, is 0.1 to 20.

### <Preparation of Dispersion>

3 ml of a dispersing medium and 1 mg of a specimen are put into a glass container having an inner diameter of 13 mm and a capacity of 5 ml, and after closing the container with a cover, it is shaken with hands to disperse the specimen.

Particle diameter distribution index A=(D₉₀−D₁₀)/D₅₀ (II)

(wherein D₉₀, D₅₀ and D₁₀ indicate the diameters (unit: μm) of the particles with 90 vol %, 50 vol % and 10 vol %, respectively, as counted from the smallest particle diameter).

As the dispersing medium used for the preparation of the above dispersion, it needs to select appropriate one which is inert to the fibrous fine carbon particles in consideration of surface properties of the particles and other matters. In the present invention, selection of the dispersing medium is made as follows. A dispersion is prepared in the same manner as in the case of the above-described preparation of dispersion, and after allowing the dispersion to stand for 24 hours, the middle portion of dispersion staying between the position of 1 cm from top of the dispersion and the position of 1 cm from bottom of the dispersion is visually observed. A dispersing medium capable of producing a homogeneous state of dispersion substantially free of secondary agglomerated particles is selected for use for the above purpose. Various dispersing media such as mentioned below can be cited as candidates, but for the fibrous fine carbon particles of the present invention, water can serve as a pertinent dispersing medium.

The particle size distribution index A can be determined by a dynamic light-scattering method using a particle size distribution meter. The index A is usually 0.1 to 20, preferably 1 to 15, more preferably 1 to 10.

### <Dispersion of Fibrous Fine Carbon Particles>

Next, the dispersion of the fibrous fine carbon particles according to the present invention is described. The dispersion of the present invention is characterized in that the fibrous fine carbon particles in the second embodiment of the invention described above are dispersed in a dispersing medium.

The dispersing medium used in the present invention is not specifically defined; it may be either a polar solvent or a non-polar solvent. The polar solvents usable in the present invention include, beside water, alcohols such as methanol, ethanol and isopropyl alcohol, glycols such as ethylene glycol and propylene glycol, ethers such as tetrahydrofuran and diethyl ether, monoalkyl ethers of glycols such as ethylene glycol monoethyl ether, ethylene glycol monomethyl ether and propylene glycol monomethyl ether, ketones such as acetone and methyl ethyl ketone, esters such as ethyl acetate, and carbonates such as ethylene carbonate and propylene carbonate. The non-polar solvents include various types of alkanes, aromatics and their mixtures. Of these solvents, water and alcohols are preferred in view of high affinity for the particles and good dispersibility.

The ratio of the fibrous fine carbon particles in the dispersing medium is usually 0.1 to 10% by weight. There are available various means for dispersing the fibrous fine carbon particles in a dispersing medium, such as mechanical stirring, mechanical shaking with a paint shaker or such, and application of ultrasonic waves. Use of a surfactant is also possible.

A prominent feature of the dispersion of the present invention is that because of uniform shape and length of the fibrous fine carbon particles, they are scarcely entangled with each other and won't form large agglomerates. Particularly when a polar solvent is used as the dispersing medium, dispersion is facilitated by the hydrophilic groups present in the particle surface, inhibiting formation of secondary agglomerates.

The size of the dispersed particles in the dispersion of the present invention can be measured by a dynamic light-scattering method using a particle size distribution meter or a laser diffraction scattering method. All the dispersions in which the size of the dispersed particles measured by either of the above methods falls in the below-defined range are considered to be included in the concept of dispersion in the present invention. Specifically, measurement is made on the dispersion solution which has been allowed to stand for 24 hours after dispersion of the particles by the above method. Here, the particles or agglomerates thereof with a size of 200 μm or more, which exceeds the measuring range, are outside of the scope of the present invention. The particles of these sizes are beyond the scope of capability of measurement with either of the dynamic light-scattering method or the laser diffraction method, and their existence can be confirmed by an optical microscope.

In the dispersion of the present invention, it is usually preferable that when 100 or more particles are observed, 90% or more of the whole measured particles are of a size or an agglomerate size not more than 60 μm, more preferably not more than 30 μm.

The particle size distribution index A given by the above-shown equation (II) is usually 1 to 15, preferably 1 to 10.

The fibrous fine carbon particles of the present invention have good dispersibility unexpectable from the conventional carbon materials and most notably can be dispersed in water and polar solvents to a high degree, so that they are characterized by ease of treatment. Further, they have advantages in connection to conductive properties that can be expected from their crystallinity. Therefore, the fibrous fine carbon particles of the present invention can not only be used as a composite material for the purpose of affording conductivity to various types of polymers by making use of their above-said properties, but also find a wide scope of application as a coating composition for forming an antistatic layer by dint of their good dispersibility. Especially, because of their small size and uniformity, they are useful as a conductive filler for the transparent conductive films in use for glass substrates of high surface energy, PET films, PVA films and the like. Further, by making the most of their capsule structure, they can be utilized advantageously in the field of support material for in-vivo diagnostic and monitoring reagents.

### EXAMPLES

The present invention is further illustrated by the following examples, but the invention is not limited to the following examples but includes various changes and modifications within the claimed scope of the invention.

### <Synthesis of Acrylonitrile-Methyl Acrylate Copolymer Fine Particles>

0.3 g of sodium dodecylsulfate was dissolved in 145 g of water, to which a mixture of 12.7 g of acrylonitrile, 1.8 g of methyl acrylate, 0.5 g of methacrylic acid and 0.3 g of n-butylmercaptan was added. The mixed solution was heated from room temperature while stirring at 250 to 300 rpm under a nitrogen gas flow, and on reaching 60° C. a potassium persulfate solution (a solution of 0.1 g of potassium persulfate in 5 g of water) was added to start polymerization. Polymerization was conducted at 70° C. for 3 hours. After the end of the reaction, water was removed to obtain a suspension containing 13.9 g of acrylic resin particles having an average size of 183 nm. The ratio of acrylonitrile units in these resin particles, as determined from the amount of nitrogen by elemental (C, H, N) analysis, was 79.6% by weight, and the weight-average molecular weight calculated as polystyrene determined by size-exclusion chromatography (SEC) was 4.1×10⁴.

### <Molding of Precursor>

15 g of polyvinyl alcohol (Kuraray Poval PVA217 produced by Kuraray Co., Ltd.) was dissolved in 100 g of water with stirring at 90° C. for one hour and then cooled to room temperature. To this solution, 37.2 g of the above-mentioned particle suspension (resin particle content: 3.0 g) was added and stirred at room temperature for 5 minutes. This solution was distributed 30 g each to the five laboratory dishes, left at room temperature for 5 hours, causing evaporation of water, and concentrated until the PVA solid concentration became 30% by weight, thereby preparing a gel.

17.3 g of this gel was put into a 200 μmφ spinning nozzle heated to 90° C., and pressed by a piston to extrude the gel into the form of 50 to 120 μmφ thread, obtaining 2.4 g of dry thread-like PVA gel containing the acrylic resin particles.

This thread-like PVA was cut uniformly to a length of cm, and with both ends of the thread clamped 1 cm each by a chuck, it was heated at 140° C. and mechanically stretched at a rate of 30 cm/min till reaching 18 cm to obtain 1.3 g of stretched thread. This stretched thread was immersed in ml of water, dissolving PVA by stirring at room temperature for 20 minutes to obtain a suspension of stretched acryl particles. This suspension was centrifuged under the conditions of 20° C. and 180,000 rpm and the supernatant was removed. The precipitated acryl particles were washed with water in the similar way to obtain an emulsion of stretched acryl particles. The acryl particles in the emulsion were determined to be the stretched polymer particles measuring 65 to 90 nm in minor diameter and 600 to 800 nm in major diameter from SEM photographic image observation.

### Example 1

13.2 g of the said emulsion of stretched acrylic particles (amount of polymer particles: 0.1 g) and 17.7 g of ethanol were mixed in a 100 ml capacity vessel, to which 8.3 g of a methyl silicate oligomer (MKS Silicate MS51 (trade name) produced by Mitsubishi Chemical Corporation) was added and the vessel was shaken. Then the vessel was stoppered and left stationary for 3 days to form a gel having no fluidity, thus making a silica gel containing polymer particles. This gel was transferred to a glass dish and dried in vacuo at room temperature for 10 hours.

The thus obtained dry gel was heated in an electric oven from room temperature to 1,000° C. at a rate of 5° C./min in a nitrogen atmosphere and kept at 1,000° C. for one hour to carbonate the polymer particles. Then heating was stopped, and after the lapse of 12 hours in which period the electric oven has been cooled down to room temperature, the sample was taken out. This was mixed in 60 ml of a 1 mol/L sodium hydroxide solution, placed in a pressure vessel and heated at 170° C. in an oven for 6 hours to dissolve the silica gel, thereby obtaining a dispersion having the carbonized particles dispersed therein. This dispersion was centrifuged at 18,000 rpm and, after removing the supernatant, the precipitated carbonized particles were washed with water three times in the similar way to obtain a dispersion of carbon particles.

The arbitrarily selected particles in the said dispersion were scanned by AFM Tapping Mode under the following conditions and subjected to an image analysis by the above-said method. In this analysis, 3 arbitrary visual fields in the image were chosen as object of measurement. Hd was 30.08 nm, and surface roughness in the respective visual fields determined by the following equation (III) was 10.3%, 11.2% and 9.8%, respectively (average: 10.4%).

Surface roughness(%)=((Sd−30.08)/30.08)×100 (III)

### (AFM Measuring Conditions)

Apparatus: NanoscopeIII Multimode, Digital Instruments Co., Ltd.
Measuring mode: Tapping Mode
Probe: NCH-10 V in the atmosphere, L=119 μm; spring constant=40 N/m
Measuring frequency: 316 kHz in the atmosphere
Measuring region: 100 nm
Number of times of data sampling: 512 in both X and Y directions
Measuring environment: in the atmosphere, at room temperature

### (AFM Sample Preparation Method)

A solution in which the sample had been suspended was dropped, by an amount of 20 μL, onto an AFM measuring cover glass, then 3 minutes later, the liquid was substantially sucked up by a filter paper and the cover glass was left as it was for drying. This cover plate was attached to a 1.5 cmφ steel plate with a double-sided tape to make a sample for tapping measurement.

Observation of the structure of the particles in the said dispersion by a transmission electron microscope (TEM) (×800,000 magnification) confirmed that these particles were of a structure having in the inside one hollow portion enclosed by a carbon crystal wall, with the carbon crystal edge being exposed at both ends of the structure. They formed aggregates measuring 800 to 1,000 nm in major diameter and 80 to 100 nm in minor diameter with an average aspect ratio of 10. The particles or particle agglomerates having a size of 100 μm or more were not present in the visual fields.

The state of dispersion of the said particles in water was determined by a dynamic light-scattering type particle size distribution meter, which confirmed that the particles were of a size distribution in which the diameter D₅₀ of the particles at the center of the distribution was 315 nm, the diameter D₁₀ of the particles with a 10 vol % distribution was 154 nm, the diameter D₉₀ of the particles with a 90 vol % distribution was 2.13 μm, and the particle size distribution index A was 6.27.

Crystallinity of the said particles was determined by an analysis of the peak which appeared at 2θ=25.6° in XRD diffraction, finding that the peak half-width was 4.5° and the interfacial distance of the crystallites was 3.47 Å. The main component elements were carbon, nitrogen and oxygen, and their detected concentrations were as follows: carbon=80.72 wt %; nitrogen=5.84 wt %; oxygen=6.41 wt %. As for the other elements, hydrogen concentration was 0.81 wt % and silicon concentration was below the identification limit (1 wt %).

### Example 2

A methyl silicate oligomer “MS51” was mixed and dispersed in a mixture of 21.2 g of water and 27.1 g of ethanol, and then 1 mol/L of hydrochloric acid was mixed to prepare a solution with pH 2. The solution was stirred at room temperature for one hour, hydrolyzing the methyl silicate oligomer and preparing a silica gel as a homogeneous solution.

78.3 g of the above silica gel was added to 26.1 g of an emulsion of the stretched acryl particles (amount of polymer particles: 0.2 g) prepared in the same manner as in Example 1, and the solution was shaken for mixing, distributed 9 grams each to twelve 8 cmφ laboratory dishes made of Teflon (registered trade name) and heated on a 40° C. hot plate for 5 hours for drying to obtain a silica gel having the polymer particles dispersed therein. This gel was transferred to a glass dish and dried in vacuo at room temperature for 10 hours.

The thus obtained dry gel was heated in an electric oven from room temperature to 1,000° C. at a rate of 5° C./min in a nitrogen atmosphere and kept at 1,000° C. for one hour to carbonate the polymer particles. Then heating was stopped, and after the lapse of 12 hours in which period the electric oven has been cooled down to room temperature, the sample was taken out. This sample was mixed in 60 ml of a 1 mol/L sodium hydroxide solution, put into a pressure vessel and heated in an oven at 170° C. for 6 hours to dissolve the silica gel, thereby obtaining a dispersion having the carbonized particles dispersed therein. This dispersion was centrifuged at 18,000 rpm and after removing the supernatant, the precipitated carbonized particles were washed with water three times in the similar way to obtain a dispersion of carbon particles.

This dispersion was subjected to 3-minute ultrasonic dispersion, and the arbitrarily selected 3 drops of dispersion were placed on a glass plate and observed by an optical microscope (×100 magnification). It was found that none of the drops contained the carbon particles and agglomerates thereof having a size of 100 μm or more.

AFM measurement was made on the arbitrary particles in the said dispersion under the same conditions as in Example 1. Also, analysis of the measured images was made in the same way as in Example 1, and surface roughness was determined for the three visual fields. Hd=30.08 nm: surface roughness of the visual fields=13.1%, 11.9% and 21.7% (average: 15.6%).

TEM (×800,000 magnification) observation of the particles in the said dispersion confirmed that these particles were of a structure having in its inside one hollow portion enclosed by a carbon crystal wall, with the carbon netplanes being laminated substantially vertically to the longitudinal direction of the fiber, as shown in FIG. 4(a). They also formed an aggregate measuring 500 to 700 nm in major diameter and 40 to 60 nm in minor diameter with an average aspect ratio of 12.

The state of dispersion of the said particles in water was determined by a dynamic light-scattering type particle size distribution meter, which confirmed that these particles were of a monodisperse size distribution in which the particle diameter D₅₀ at the center of the distribution was 235 nm, the diameter D₁₀ of the particles with 10 vol % distribution was 126 nm, the diameter D₉₀ of the particles with 90 vol % distribution was 431 nm, and the particle size distribution index A was 1.30.

Crystallinity of the particles was determined by an analysis of the peak which appeared at 2θ=25.60 in XRD diffraction, finding that the peak half-width was 4.1° and the interfacial distance of the crystallites was 3.47 Å. The main component elements were carbon, nitrogen and oxygen with the detected concentrations of 85.36 wt %, 6.52 wt % and 6.82 wt %, respectively. As for the other elements, hydrogen was below the identification limit (0.3 wt %) and silicon was also below its identification limit (1 wt %).

### Comparative Example 1

12.8 g of an emulsion of stretched acryl particles (amount of polymer particles: 0.1 g) prepared according to Example 1 was allowed to stand for 24 hours for drying without being dispersed in silica gel, and carbonized after the manner of Example 1. Thereafter the same procedure as in Example 1 was carried out under the same conditions to obtain a dispersion of carbonized particles.

TEM (×800,000 magnification) observation of the structure of the particles in this dispersion showed total absence of fibrous fine carbon particles in the dispersion. Also, the particles in this dispersion were diversified in shape and size, and they were the particles and agglomerates thereof whose carbon crystal structure could not be confirmed. Most notably, there was admitted no hollow portion in the particles.

20 mg of the particles in the above dispersion were mixed in 10 ml of water and dispersed ultrasonically for 3 minutes. Then one drop of the dispersion, picked up arbitrarily, was placed on a glass plate and observed by an optical microscope (×100 magnification). Presence of many carbon particles having a size of 100 μm or more was observed.

Crystallinity of the particles was determined by analyzing the peak appearing at 2θ=24.7° in XRD diffraction. It was found that the peak half-width was 6.7° and the interfacial distance of the crystallites was 3.61 Å. These indicate low crystallinity of the product of Comparative Example 1.

### Comparative Example 2

40 ml of water was placed in a round flask, to which 4.7 g of cobalt nitrate, 1.4 g of ammonium molybdate and 14.5 g of magnesium nitrate were added and stirred for one hour. Water was removed over a period of 18 hours at 40° C. under reduced pressure. The mixture was further dried over a period of 30 minutes at 150° C. under 10 mmHg and then heated at 550° C. (heated up from room temperature at a rate of 5° C./min) for 6 hours to obtain 5.2 g of a solid. The result of an analysis of this solid showed that it contained Co, Mo and MgO in the molar ratios of 0.2, 0.1 and 0.7, respectively. This solid was pulverized by a jet mill and passed through a 80-mesh sieve, and the resultant material was used as a catalyst for the following reaction.

0.6 g of the said catalyst was placed stationary on a quartz glass boat in a quartz glass reacting tube (10.2 L), and after purging the inside of the reacting tube with nitrogen gas, it was heated to 600° C. and hydrogen gas was introduced thereinto for one hour to reduce the catalyst surface. Thereafter, the introduced gas was converted to a composition of 0.9 L/min carbon monoxide and 0.1 L/min hydrogen and continuously passed for 6 hours to precipitate the carbon material on the catalyst surface. After the end of the reaction, the carbon-precipitated product was recovered in a yield of 19.4 g (yield includes weight of the recovered catalyst).

TEM (×800,000 magnification) observation of the structure of the obtained carbon product showed that there existed no capsule-like fine carbon particles having a hollow structure closed at both ends and enclosed by a wall comprising an oriented carbon crystal layer, and that this product has a fibrous cylindrical structure with a diameter of 20 to 40 nm, or in other words, it mainly comprised a fibrous carbon nanotube structure which is hollow at the central portion and has a wall of a graphene laminated structure. The crystal layer was of a herringbone-weave structure not parallel to the longer axis at any position. As the products other than this carbon product, there were observed the carbon fibers having no crystallinity and measuring 50 to 500 nm in diameter and 100 nm or more in length, aggregates of the crystalline carbon fibers having the catalyst metal particles in the center and supposed to have grown radially in two or more directions therefrom, and the entangled masses of such aggregates of carbon fibers.

8 mg of the above carbonized product was put into 400 μL of ethanol and dispersed ultrasonically for 5 minutes, and AFM measurement was made on the carbonized product in this solution under the same conditions as in Example 1. In the AFM measurement, the singly separated fibrous solids of 20 to 40 nm in diameter were selected from the microscopic images as the objects of measurement. Further, analysis of the measured images was conducted in the same way as in Example 1 and surface roughness was determined for the three arbitrary visual fields. Hd was 30.08 nm, and surface roughness of the three visual fields was 5.4%, 3.9% and 5.5%, respectively (average: 4.93%). Surface roughness was smaller than the products of the Examples.

20 mg of the said carbonized product was mixed in 10 ml of water and dispersed ultrasonically for 3 minutes, and one drop of this suspension was collected arbitrarily, placed on a glass plate and observed under an optical microscope (×100 magnification). There were observed many carbon particles having a size of 100 μm or more.

### Comparative Example 3

An aluminum plate was anodized in 20 wt % sulfuric acid at 10° C. and 20 V for 2 hours to form an anodized coating film having a pore diameter of 33 nm and a thickness of 70 μm. A carbon film was deposited on this anodized coating film by conducting CVD in the presence of propylene gas (1.2 vol % in nitrogen) at 800° C. for 2 hours to form a composite carbon/anodized coating film. CVD was further conducted on this composite film in the presence of acetonitrile gas (4.2 vol % in nitrogen) at 800° C. for 5 hours to deposit another carbon film as the second layer to form a carbon/carbon/anodized coating film.

This composite coating film was treated in a 10 mol/L sodium hydroxide solution at 150° C. for 6 hours to remove the basal anodized coating film and aluminum plate to obtain a fibrous carbon product. From observation of TEM images (×400,000 magnification) and SEM images (×20,000 magnification), the carbon product was confirmed to be the nm diameter carbon nanotubes having a hollow structure open at one end and uniform in length at 70 μm. 2 mg of this carbonized product was put into 100 μL of ethanol and dispersed ultrasonically for 5 minutes. AFM measurement of the carbonized product in this dispersion was made under the same conditions as in Example 1, and an analysis of the measured images was conducted in the same way as in Example 1 to determine surface roughness for the 3 arbitrary visual fields. Hd: 25.05 nm; surface roughness of the 3 visual fields: 4.30%, 4.41% and 4.44% (average: 4.38%). Surface roughness of the carbon nanotubes formed on the alumina coating film by anodizing was smaller than that of the products in the Examples.

1. Fibrous fine carbon particles having minor diameter of 5 nm to 5 μm and having a rugged structure in which the mean value of surface roughness defined by the following equation (I) is not less than 8.0%:
Surface roughness(%)=((Sd−Hd)/Hd) (I)
(wherein in determination of surface roughness, surface ruggedness of the fine carbon particles is measured by AFM Tapping Mode, forming the two-dimensional images of the particles from the obtained data, then an arbitrary straight line is selected on the two-dimensional images, forming the outline from the above data corresponding to said straight line, then a section of measurement (S) is selected, said section being an area where the length of the virtual straight line connecting the two points on the said outline is within the range of 20 to 35 nm, and with the length of the virtual straight line between the said two point being represented by Hd and the length of the actual outline between the two point being represented by Sd, surface roughness is calculated from the above equation (I); the section of measurement (S) is a portion where the deviation of the outline from the virtual straight line is ±0.5 Hd.)

2. The fibrous fine carbon particles according to claim 1, wherein the major diameter of the particles is 40 nm to 10 μm.

3. The fibrous fine carbon particles according to claim 1 having a crystalline carbon structure.

4. The fibrous fine carbon particles according to claim 1 having formed therein a single hollow portion enclosed by a carbon crystal wall.

5. The fibrous fine carbon particles according to any one of claim 1 having a structure in which the carbon crystal edge is exposed at least at both ends.

6. Fibrous fine carbon particles having formed therein a single hollow portion enclosed by a carbon crystal wall and having a structure in which the carbon crystal edge is exposed at least at both ends of the particles, which fibrous fine carbon particles has the major diameter of 40 nm to 10 μm and the minor diameter of 5 nm to 5 μm.

7. An aggregate of the fibrous fine carbon particles as defined in claim 5 having such a property that with reference to the dispersion prepared by the method described below, the particle size distribution index A determined by allowing the dispersion to stand for 24 hours after its preparation and represented by the following equation (II) is 0.1 to 20:
<Preparation of dispersion>
3 ml of a dispersing medium and 1 mg of a specimen are placed in a glass vessel having an inner diameter of 13 mm and a capacity of 5 ml and, after closing the vessel with a cover, it is shaken with hands to disperse the specimen.
Particle size distribution index A=(D₉₀−D₁₀)/D₅₀ (II)
(wherein D₉₀, D₅₀ and D₁₀ indicate the diameters (unit: μm) of the particles with 90 vol %, 50 vol % and 10 vol %, respectively, as counted from the smallest particle diameter.)

8. A dispersion of the fibrous fine carbon particles formed by dispersing the fibrous fine carbon particles as defined in claim 7 in a dispersing medium.

9. A method for producing the fibrous fine carbon particles of claim 1 which comprises using as raw material the fibrous carbon precursor particles of a predetermined length with its minor diameter being selected from the range of 5 nm to 5 μm, and carbonizing said raw material in its proto-shaped mold.

10. A method for producing the fibrous fine carbon particles as defined in claim 6 which comprises using as raw material the fibrous carbon precursor particles of a predetermined length with its major diameter being selected from the range of 40 nm to 10 μm and its minor diameter selected from the range of 5 nm to 5 μm, and carbonizing the raw material in its proto-shaped mold.

11. The method according to claim 9, wherein the proto-shaped mold of said raw material is formed by coating the raw material with a thermostable material by a sol/gel reaction.

12. The method according to claim 9, wherein the carbon precursor is a material capable of a liquid-phase carbonization.

13. The method according to claim 9, wherein the carbon precursor contains a pyrolitic polymer.
